(19) United States
(12) Patent Application Publication
(10) Pub. No.: US 2017/0046423 A1
(43) Pub. Date: Feb. 16, 2017

(54) Virtualizing Data Processing for Analytics and Scoring in Distributed Heterogeneous Data Environments

(71) Applicant: Boomi, Inc., Berwyn, PA (US)

(72) Inventors: Michael J. Morton, Morrisville, NC (US); George R. Butler, Tulsa, OK (US); Ivan I. Korsakov, Tulsa, OK (US); Richard A. Backhouse, Apex, NC (US); Thomas Hill, Tulsa, OK (US)

(73) Assignee: Boomi, Inc., Berwyn, PA (US)

(21) Appl. No.: 14/826,750

(22) Filed: Aug. 14, 2015

(51) Int. Cl. G06F 17/30

(52) U.S. Cl. CPC G06F 17/30604; G06F 17/30312

(57) ABSTRACT

A system, method, and computer-readable medium for virtualizing in-database operations such as complex analytic and scoring computations, and de-coupling these operations from the specific underlying database or data storage platform and location.

### BACKGROUND OF THE INVENTION

### Field of the Invention

The present invention relates to information handling systems. More specifically, embodiments of the invention relate to virtualizing data processing for analytics and scoring.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems to collect and store large amounts of data. Many technologies are being developed to process large data sets (often referred to as “big data”, and defined as an amount of data that is larger than what can be copied in its entirety from the storage location to another computing device for processing within time limits acceptable for timely operation of an application using the data).

One issue in known big data environments is providing efficient and flexible methods and technologies for performing analytics tasks on the large data sets which may be stored within no-SQL type databases as well as other data stores. It is known to provide in-database processing by locating the analytics operations closer to the data sets. For example, it is known to provide map-reduce implementations of known data processing algorithms within data stores such as the Hadoop data store. Map-reduce implementations of known data processing algorithms divide the computational task into two components: one component where the statistical summaries are accumulated at a respective data store node for the respective data stored at that node (i.e., the reduce part of the implementation) and another component which then aggregates the sub-aggregates computed at the node level to generate the final results (i.e., the map part of the implementation). However, these known solutions for in-database processing present certain issues. For example, the known solutions are often targeted and designed for specific databases and data stores. However, many known data stores for large data sets are hybrids of structured query language (SQL) type platforms and noSQL type platforms (i.e., database platforms that allow for storage and retrieval of data that is modeled in means other than the tabular relations used in relational databases). NoSQL type platforms are also sometimes referred to as “not only SQL” to emphasize that they may support SQL-like query languages.

Additionally, many known data stores for large data sets are configured as hybrids of on-premises and off-premises (e.g., cloud-based) data stores. Additionally, solutions targeted and designed for a specific database often do not transfer to other database platforms. For example, social media analytics often rely upon web-based streaming data which then needs to be merged with other data relevant to a respective use case (e.g., marketing) for subsequent processing. Additionally, many known solutions are configured so that the data within the database are not externally accessible (i.e., from outside of the firewall or network of the database). With such a configuration it would be desirable to provide the database with internal (i.e., within the firewall or network of the database) data processing capabilities.

### SUMMARY OF THE INVENTION

A system, method, and computer-readable medium are disclosed for virtualizing in-database operations such as complex analytic and scoring computations, and de-coupling these operations from the specific underlying database or data storage platform and location.

More specifically, in certain embodiments, in-database operations comprise operations executing within and supported by a specific database (e.g., in SQL form or as a stored procedure expressed in a language such as Java, C# or C++). In certain embodiments, the solution may be a proprietary solution where specific computer codes is developed in a suitable computer language to enable custom computations. The in-database operations achieve performance benefits due to data never needing to leave the database and optimizations due to low-level access to implementation details of the specific database or database management system. The virtualized in-database operations provide a hybrid approach where a workspace expresses an abstracted analytic data flow that can be transferred to the specific database. In various embodiments, the abstracted analytic data flow is partially pushed such as via a piece-by-piece data flow or as a group of chained nodes. By providing a hybrid approach, if certain nodes do not support the abstracted analytic data flow, then the analytic data flow is performed using data obtain from these certain nodes, while nodes which support the abstracted analytic data flow perform the operations in-database.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of an environment for virtualizing data processing for analytics and scoring.

FIG. 3 shows a flow chart of the operation of virtualizing data processing for analytics and scoring.

### DETAILED DESCRIPTION

A system, method, and computer-readable medium are disclosed for virtualizing in-database operations such as complex analytic and scoring computations, and de-coupling these operations from the specific underlying database or data storage platform and location.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

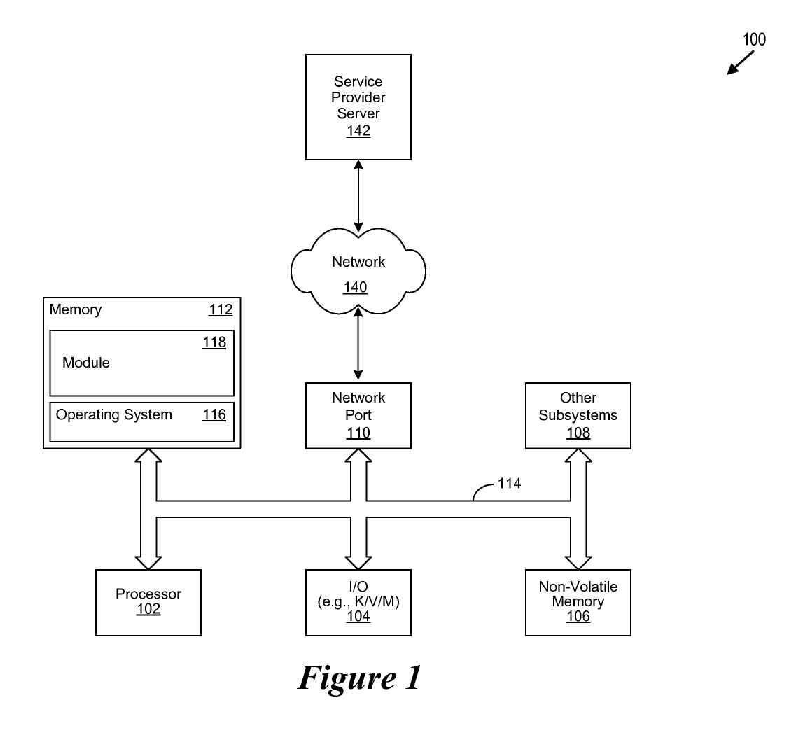

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a memory 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an in-database virtualization module 118.

The in-database virtualization module 118 virtualizes in-database operations such as complex analytic and scoring computations, and de-couples these operations from the specific underlying database or data storage platform and location.

More specifically, in certain embodiments, in-database operations comprise operations executing within and supported by a specific database (e.g., in SQL form or as a stored procedure expressed in a language such as Java, C# or C++). In certain embodiments, the solution may be a proprietary solution where specific computer codes are developed in a suitable computer language to enable custom computations. One example of a proprietary solution would be computer code developed to compute credit risk scores or fraud risk scores from multiple data sources that also include unstructured text data. The in-database operations achieve performance benefits due to data never needing to leave the database and optimizations due to low-level access to implementation details of the specific database or database management system. The virtualized in-database operations provide a hybrid approach where a workspace expresses an abstracted analytic data flow that can be pushed to the specific database. In various embodiments, the abstracted analytic data flow is partially pushed such as via a piece-by-piece data flow or as a group of chained nodes. By providing a hybrid approach, if certain nodes do not support the abstracted analytic data flow, then the analytic data flow is performed using data obtain from these certain nodes, while nodes which support the abstracted analytic data flow perform the operations in-database.

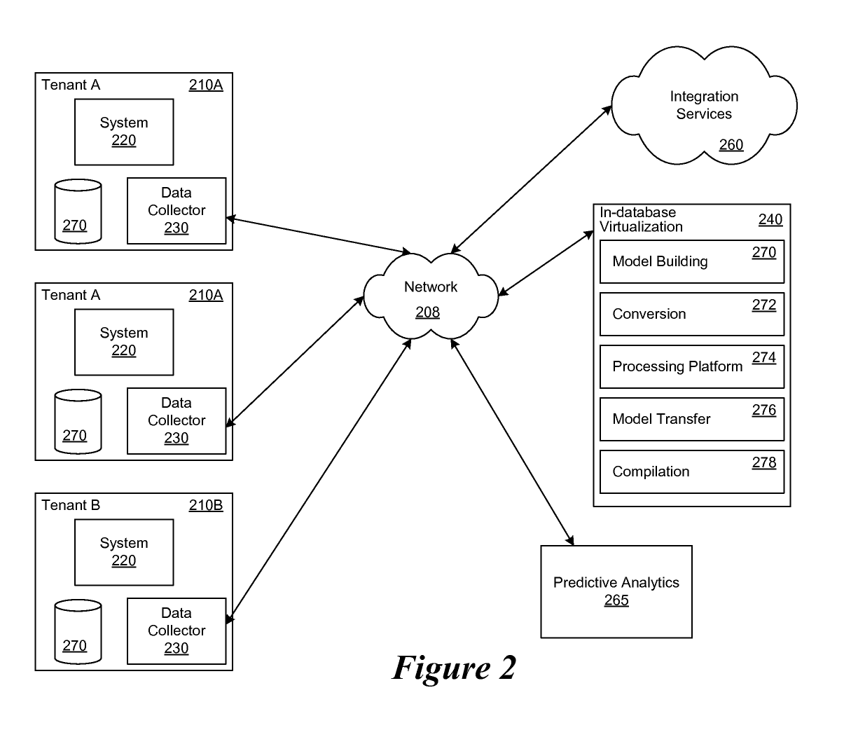

FIG. 2 shows a block diagram of an environment 200 for virtualizing data processing for analytics and scoring. In the environment 200, tenant systems 210 connect to the in-database virtualization system 240 over a network 208, which may be a private network, a public network, a local or wide area network, the Internet, combinations of the same, or the like. In various embodiments, the network 140 is included within the network 208. In various embodiments, a firewall may be located between one or more of the tenant systems 210 and the network 208. The firewall monitors and controls the incoming and outgoing network traffic based on an applied security rules. The firewall establishes a barrier between a trusted, secure internal network (e.g., a network within a tenant system 210 or coupling a plurality of tenant systems 210) and another outside network, such as the Internet, that is assumed to not be secure or trusted.

Each of the tenant systems 210 can represent an installation of physical and/or virtual computing infrastructure. Collectively, the tenant systems 210 can represent a federated aspect of the environment 200. In general, the tenant systems 210 provide various computing functions including data store and database functionality. The environment further includes an integration services system 260 as well as a predictive analytics system 265 which each communicate with the tenant systems 210 and the in-database virtualization system 240 via the network 208.

The in-database virtualization system 240 performs an in-database virtualization operation which virtualizes in-database operations such as complex analytic and scoring computations, and de-couples these operations from the specific underlying database or data storage platform and location. In various embodiments, the in-database virtualization module 218 includes some or all of the components of the in-database visualization system 240.

The in-database virtualization system 240 includes a plurality of components. More specifically, in various embodiments, the in-database virtualization system 240 includes one or more of a model building component 270, a conversion component 272, a data and database processing platform component 274, a model transfer component 276, and a compilation component 278.

The model building component 270 includes a computational platform for building analytic models. More specifically, in certain embodiments, the analytic models include predictive models such as where outcome variables Y are predicted from vectors of inputs X, Y=f(X). In certain embodiments, the analytic models include models for building cluster, Principal Components, and other models where some latent dimensions or clusters (y′) are computed from vectors of inputs X; Y′=f(X). In certain embodiments, the model building component 270 comprises a predictive analytics system such as the Statistica predictive analytics system available from Dell, Inc.

The conversion component 272 provides conversion functionality for converting models to symbolic computer machine readable form. In certain embodiments, the symbolic computer machine readable form comprises a standard computer programming language. In various embodiments, the standard computer programming language comprises one or more of the Java computer programming language, the C# computer programming language as well as versions of SQL which include programming functionality.

The data and database processing platform component 274 provides interfaces and queries to enable virtualized views to diverse data sources as if the data sources represent a single source. In various embodiments, the diverse data sources include on-premises data sources as well as off-premises data sources such as cloud type data sources. Additionally, the data and database processing platform component 274 enables building of complex data flows against such sources. More specifically, process of building of complex data flows against such sources connects to one or more data sources and types, to retrieve the desired data either as-is (i.e., as not transformed data) and/or desired data transformed, or a combination of both such that the end result of the data retrieval, optional transformation, is an integration flow that can be designed and executed to provide the data needed for the model/analytics to operate on to produce a result (e.g., scoring). In certain embodiments, this process is referred to as an integration process. Additionally, the data and database processing platform component 274 enables writing of transformed and merged data tables back to desired data locations. In certain embodiments, the data and database processing platform component 274 comprises an integration platform as a service (iPaaS) such as the Boomi AtomSphere integration platform system available from Dell, Inc. Additionally, in certain embodiments, the data and database processing platform component 274 comprises an instantiation of a Toad Intelligence Central (TIC) type system available from Dell, Inc.

The model transfer component 276 enables the in-database virtualization system 240 to transfer any developed models in symbolic form to the virtualized data processing platform. For example, in certain embodiments, the model transfer component 276 enables the system for virtualizing in-database operations 276 to transfer Java-based models from a predictive analytics system such as the Statistica solution available from Dell, Inc. to an on-premises integration of the integration platform such as a Boomi Atom of the Boomi AtomSphere integration platform. In certain embodiments, the developed models may be transferred to an off-premises integration (e.g., a cloud integration) of the integration platform. In certain embodiments, the developed models may be transferred to a combination of an on-premises integration and an off-premises integration.

The compilation component 278 provides functionality which allows the environment 200 for virtualizing data processing for analytics and scoring to compile the models in symbolic form (e.g., Java) into machine-interpretable data processing steps that can be directly executed inside the tenant system 240. In certain embodiments, the compile modes are optimized via optimized processing of the models. In certain embodiments, the optimized processing in the tenant system 240 may also include transferring computations to the respective data or database location for fastest processing. It will be appreciated that the model can be compiled at the tenant system or can be precompiled prior to providing the model to the tenant system.

In certain embodiments, a portion of the compilation component 278 is included within a computational analytics platform. The computational analytics platform then publishes information to the virtualized data management platform. The published information includes information regarding where to send data for scoring (X) and then query for results (Y or Y′). With such a publication operation, actual model based data processing can be performed within the computational analytics platform or elsewhere within the environment 200. For example, in certain embodiments, an integration platform such as the Boomi AtomSphere integration platform may use a service published by a predictive analytics system (e.g., a Live Score service of the Statistica predictive analytics system) and call that service to perform an efficient complex model scoring.

The tenant systems 210 can be owned or operated by the same or different entities. For example, two of the tenant systems 210 installed in separate locations are shown as owned or operated by “Tenant A,” while another system 210 is owned or operated by a different tenant, “Tenant B.” Tenants A and B can represent customers (e.g., entities such as companies or individuals) of an operator of the central analysis system 240. Although the term “tenant” is used herein to describe the systems 210 or owners/operators thereof, in addition to having its ordinary meaning, the term “tenant” can, but need not, refer to tenancy in a multitenant software architecture.

Each of the tenant systems 210 includes one or more systems 220. The systems 220 can include physical and/or virtual computing devices, such as physical machines and/or virtual machines. For instance, a system 220 may include any of the following: an information handling system, a virtual machine, server, web server, application server, database, application, processor, memory, hard drive or other storage device, peripheral, software component, database tables, tablespaces in a database, application tiers, network switches or other network hardware, combinations of the same or the like. Any given tenant system 210 can include from one to several systems 220. For example, a tenant system 210 can represent an entire data center having hundreds or even thousands of systems 220.

Data collectors 230 and local data stores 270 can be provided in some or all of the tenant systems 210. In the depicted embodiment, data collectors 230 and local data stores 270 are shown in a pair of the tenant systems 210A. In some embodiments, the tenant systems 210 can additionally maintain a cache (not explicitly shown) for storing information derived from the systems 220 and/or the data elements in the local data store 270. In these embodiments, the tenant systems 210, or the data collectors 230, could be configured to periodically obtain the information and store in the cache.

The data collectors 230 can be software and/or hardware agents, appliances, or the like that collect data about the systems 220. This data can include time-series data related to the performance of physical and/or software components (including virtual components), such as performance related to any of the systems 220. The data can also include information about attributes, characteristics, or properties of the systems 220, such as the number of processors in each host device, memory or storage capacity, hardware or software specifications, virtual machine characteristics, and so forth. The data collectors 230 can collect this data in real-time, periodically, e.g., according to a schedule, on-demand, or a combination of the same, and store the monitoring data in the local data stores 270. In some tenant system 210 installations having many systems 220, one or more management servers (not shown) can manage data collection of a plurality of data collectors 230.

Additionally, in certain embodiments, the data collectors 230 include a first connector module and a second connector module to facilitate performing the in-database analytics operations. In certain embodiments, the first connector module may be considered a data connector and the second connector module may be considered a model manager connector.

The first connector module connects to and retrieves any desired data from a data source. The first connector module singularly or in combination facilitates an ability to securely connect to data sources for the purpose of data retrieval. In various embodiments, there may be a plurality of data sources each of which is coupled to a respective first connector module. In various embodiments, the first connector modules may be configured in a plurality of usage scenarios. More specifically, in a single connector module usage scenario, the single connector module is sued to connect to a data source for the purpose of retrieving any desired data. In a multiple connector module usage scenario, a plurality of first connector modules is used to connect to and retrieve data from a plurality of data sources. This multiple connector module usage scenario enables the ability to join data from multiple sources in a data center (at a single tenant) and feed the data to the model and/or analytics as if the data originated from a single source. In another multiple connector module usage scenario, a plurality of first connector modules are used to connect to and retrieve data from a plurality of sources as well as to transform the data into a proper format (i.e., a format that can be understood by the model) if required and to feed the data in aggregate to the model and/or analytics as if the data originated from a single source and in the proper format. Each of the plurality of first connector modules in this scenario includes a data connection component and a data transformation component.

The second connector module interacts with the processing platform (e.g., the predictive analytics system 265) to manage the interaction of obtaining a model and making the model available for execution at a tenant system 210 associated with the particular second connector module.

The data collectors 230 store the collected data in the local data stores 270. In addition, the data collectors 230 can provide the collected data to some or all of the integration services 260, the predictive analytics system and the in-database virtualization system 240 upon request, or, in some cases, as a live stream. Other tenant systems 210 that do not have local data collectors 230 can interact directly with the integration services system 260 as well as the predictive analytics system 265.

The in-database virtualization system 240 can access this data remotely by querying libraries or APIs of the tenant systems 210B, thereby replacing the functionality of the data collectors 230 in some embodiments. More generally, in other embodiments, local data collectors 230 or other agents may be omitted, or each tenant system 210 can include one or more data collectors 230.

For smaller computing environments, the integration services 260 can be implemented as a single management server. Alternatively, the integration services 260 can be implemented in a plurality of virtual or physical servers, which may or may not be geographically co-located. For example, the integration services 260 and/or other aspects of the environment 200 may be hosted in a cloud-based hosting service such as the Azure™ service provided by Microsoft® or the EC2™ platform provided by Amazon®.

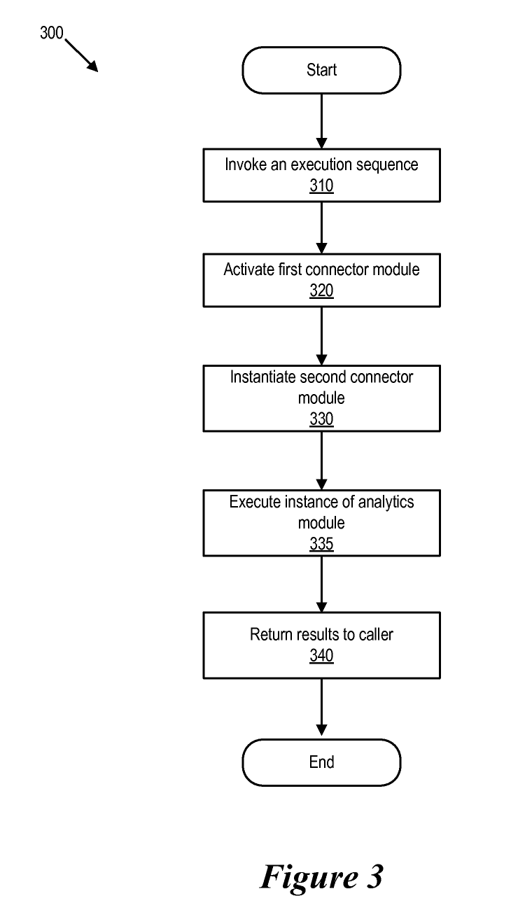

FIG. 3 shows a flow chart of the operation of virtualizing data processing for analytics and scoring. More specifically, the operation of virtualizing data processing for analytics and scoring starts at step 310 by a caller invoking an execution sequence of operating on data. Next, at step 320, a first connector module is activated. The first connector module access to a desired data source and obtains the data to be operated on by an analytics module. In certain embodiments, the analytics module comprises analytics scoring logic such as that provided via the predictive analytics system 265. There may be multiple data sources that need to be accessed to provide the data and thus multiple connector modules are used to obtain this data.

Next at step 330, a second connector module is instantiated. The second connector module accesses a data processing application (e.g., a Statistica instance). In certain embodiments, this access is via a Web Service call. After accessing the data processing application, the connector module retrieves an instance of the analytics module. In certain embodiments, the instance of the analytics module includes the software code necessary to perform the desired operation. For example, the instance of the analytics module could include Java code for operating on a Java enabled database. Next at step 335, the second connector executes the instance of the analytics module on the data that was obtained by the first connector module during step 320.

Next, at step 340, the results obtained from the execution of the instance of the analytics module are returned to the caller that invoked the execution sequence.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for virtualizing in-database operations, comprising:
expressing an abstracted analytic data flow;
transferring the abstracted analytic data flow to a specific database;
executing the abstracted analytic data flow in-database while de-coupling the abstracted analytic data flow from the specific database.

2. The method of claim 1, wherein:
the abstracted analytic data flow comprises complex analytic and scoring computations.

3. The method of claim 1, wherein:
the abstracted analytic data flow is partially transferred to the specific database.

4. The method of claim 1, further comprising:
determining whether certain nodes within the specific database can support the abstracted analytic data flow;
externally performing the abstracted analytic data flow using data obtained from the certain nodes if the certain nodes do not support the abstracted analytic data flow.

5. The method of claim 1, wherein:
the executing the abstracted analytic data flow in-database while de-coupling the abstracted analytic data flow from the specific database comprises providing a first connect module and a second connector module, the first connect module enabling a database node to receive the abstracted analytic data flow, the second connector module executing the abstracted analytic data flow.

6. The method of claim 5, wherein:
the first connector module comprises a data connector module and the second connector module comprises a model manager connector module.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
expressing an abstracted analytic data flow;
transferring the abstracted analytic data flow to a specific database;
executing the abstracted analytic data flow in-database while de-coupling the abstracted analytic data flow from the specific database.

8. The system of claim 7, wherein:
the abstracted analytic data flow comprises complex analytic and scoring computations.

9. The system of claim 7, wherein:
the abstracted analytic data flow is partially transferred to the specific database.

10. The system of claim 7, wherein the instructions executable by the processor are further configured for:
determining whether certain nodes within the specific database can support the abstracted analytic data flow;
externally performing the abstracted analytic data flow using data obtained from the certain nodes if the certain nodes do not support the abstracted analytic data flow.

11. The system of claim 7, wherein:
the executing the abstracted analytic data flow in-database while de-coupling the abstracted analytic data flow from the specific database comprises providing a first connect module and a second connector module, the first connect module enabling a database node to receive the abstracted analytic data flow, the second connector module executing the abstracted analytic data flow.

12. The system of claim 11, wherein:
the first connector module comprises a data connector module and the second connector module comprises a model manager connector module.

13. A non-transitory, computer-readable storage medium embodying computer program code, the computer program code comprising computer executable instructions configured for:
expressing an abstracted analytic data flow;
transferring the abstracted analytic data flow to a specific database;
executing the abstracted analytic data flow in-database while de-coupling the abstracted analytic data flow from the specific database.

14. The non-transitory, computer-readable storage medium of claim 13, wherein:
the abstracted analytic data flow comprises complex analytic and scoring computations.

15. The non-transitory, computer-readable storage medium of claim 13, wherein:
the abstracted analytic data flow is partially transferred to the specific database.

16. The non-transitory, computer-readable storage medium of claim 13, wherein the computer executable instructions are further configured for:
determining whether certain nodes within the specific database can support the abstracted analytic data flow;
externally performing the abstracted analytic data flow using data obtained from the certain nodes if the certain nodes do not support the abstracted analytic data flow.

17. The non-transitory, computer-readable storage medium of claim 13, wherein:
the executing the abstracted analytic data flow in-database while de-coupling the abstracted analytic data flow from the specific database comprises providing a first connect module and a second connector module, the first connect module enabling a database node to receive the abstracted analytic data flow, the second connector module executing the abstracted analytic data flow.

18. The non-transitory, computer-readable storage medium of claim 17, wherein:
the first connector module comprises a data connector module and the second connector module comprises a model manager connector module.
